(19) United States
(12) Patent Application Publication
(10) Pub. No.: US 2026/0307546 A1
(43) Pub. Date: Oct. 8, 2026

(54) ACTUATOR FOR A VEHICLE SEAT, IN PARTICULAR FOR A SQUAB-RAISING MECHANISM OF A VEHICLE SEAT

(71) Applicant: FAURECIA Sièges d'Automobile, NANTERRE (FR)

(72) Inventors: Emil RDZANEK, PIASECZNO (PL); Nicolas NAVATTE, CONDÉ SUR NOIREAU (FR)

(21) Appl. No.: 19/639,864

(22) Filed: Apr. 6, 2026

(30) Foreign Application Priority Data
Apr. 7, 2025 (FR) 2503648

(51) Int. Cl. B60N 2/02; F16H 37/12; F16H 57/12

(52) U.S. Cl. CPC B60N 2/02253; F16H 37/122; F16H 57/12

(57) ABSTRACT

An actuator for a vehicle seat comprises a motor; a reduction gear comprising a wheel with an eccentric cam driving an orbital gear wheel; an output member forming an inner ring gear receiving the orbital gear wheel; a backlash compensation washer comprising a member for rotationally coupling to the orbital gear wheel, and a toothed sector adapted to cooperate with the inner ring gear of the output member. The backlash compensation washer comprises a resiliently deformable arm between the rotational coupling member and the toothed sector.

### PRIORITY CLAIM

This application claims priority to French Patent Application No. FR2503648, filed Apr. 7, 2025, which is expressly incorporated by reference herein.

### BACKGROUND

The present disclosure relates to an actuator for a vehicle seat, in particular a motor vehicle seat. The present disclosure relates more particularly to an actuator for a squab-raising mechanism of a vehicle seat, especially a motor vehicle seat.

### SUMMARY

According to the present disclosure, a vehicle seat actuator is proposed comprising:

a motor with an output shaft,

a reduction gear driven by the output shaft of the motor, the reduction gear comprising an eccentric cam wheel driving an orbital gear wheel,

an output member, the output member forming a pinion and an inner ring gear adapted to receive the orbital gear wheel, the pinion and the inner ring gear being aligned along an axis of rotation of the output member,

a backlash compensation washer comprising at least one member for rotational coupling to the orbital gear wheel and at least one toothed sector adapted to cooperate with the inner ring gear of the output member, the backlash compensation washer comprising, between the rotational coupling member and the at least one toothed sector, at least one resiliently deformable arm.

In illustrative embodiments, the vehicle seat actuator comprises one or more of the following features, taken alone or in combination:

the orbital gear wheel is adapted to be moved in circular translation in the inner ring gear of the output member, the actuator preferably comprising a guide slide for the orbital gear wheel;

the at least one coupling member comprises at least one of a stud and a lug, secured to a central ring gear, the stud or lug being adapted to be received in a complementary housing of the orbital gear wheel in order to rotationally connect the backlash adjustment washer and the orbital toothed wheel;

the at least one arm extends in the shape of an arc of a circle between a first end, integral with the central ring gear if applicable, and a second end, integral with the at least one toothed sector;

the vehicle seat actuator comprises a plurality of distinct toothed sectors, separated from one another by an orthoradial gap;

each arm is attached to a single toothed sector;

the vehicle seat actuator comprises a single toothed sector extending over substantially the entire circumference of the backlash compensation washer;

the backlash compensation washer is substantially flat, with the exception of the at least one coupling member, in particular the at least one lug if applicable;

the backlash compensation washer comprises at least one relief projecting in the direction of the axis of rotation of the output member, adapted to come into contact with a front surface of the output member, normal to the axis of rotation of the output member; and

the at least one relief comprises at least one of:

the central ring gear; and

-an arm base connecting the arm to the central ring gear.

According to another aspect, a vehicle seat is described, comprising an actuator as described above, in all combinations thereof.

The vehicle seat may in particular comprise:

a base;

a squab frame;

at least one hinge mechanism connecting the squab frame to the base, each hinge mechanism comprising at least one connecting rod mounted to rotate freely with respect to the squab frame at a first end and to the base at a second end;

at least one actuator as described above, in any combination thereof, to control the rotation of the at least one connecting rod with respect to the base or to the squab frame.

According to another aspect, a vehicle seat is proposed comprising:

a squab frame;

a device for raising the seat front edge;

at least one connecting rod connecting the squab frame to the seat front edge raising device;

at least one actuator as described above, in any combination thereof, to control rotation of the at least one connecting rod with respect to the squab frame or seat front edge raising device.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a schematic view of a vehicle seat with adjustable squab height;

FIG. 2 shows a detail of the squab of the vehicle seat of FIG. 1;

FIG. 3 is a perspective view of an actuator that can be used in the vehicle seat shown in FIG. 1;

FIG. 4 is an exploded perspective view of the actuator of FIG. 3;

FIG. 5 is a cross sectional view of the actuator in FIG. 3, along sectional plane V-V in FIG. 3;

FIG. 6 is a detail of a longitudinal cross sectional view of the actuator shown in FIG. 3;

FIG. 7 is a perspective view of the actuator shown in FIG. 3, from a cross-section along plane VII-VII of FIG. 6;

FIG. 8 shows a perspective view of the actuator shown in FIG. 3, including the backlash compensation wheel mounted on the orbital gear wheel;

FIG. 9 is a detailed cross-sectional view of the actuator of FIG. 8;

FIG. 10 shows a perspective view of a second example of a backlash compensation washer that can be used in the actuator of FIG. 3;

FIG. 11 shows a perspective view of a third example of a backlash compensation washer that can be used in the actuator of FIG. 3; and

FIG. 12 shows a perspective view of the third example of a backlash compensation washer mounted on the orbital gear of the FIG. 3 actuator.

### DETAILED DESCRIPTION

In the various figures, the same references designate identical or similar features. For simplicity’s sake, only the elements that are useful for understanding the described embodiment are shown in the figures and are described in detail below.

In the following description, when referring to terms qualifying absolute position, such as the terms “front”, “rear”, “top”, “bottom”, “left”, “right”, etc., or relative ones, such as the terms “above”, “below”, “upper”, “lower”, etc., or to qualifiers of orientation, such as “horizontal”, “vertical”, etc., reference is made, unless otherwise specified, to the orientation of the figures or a vehicle seat in its normal position of use.

In particular, the longitudinal direction X means the longitudinal direction of the seat. The longitudinal direction of the seat is considered to be the same as the longitudinal direction of the motor vehicle wherein the seat is mounted. This longitudinal direction X corresponds to the normal direction of travel of the vehicle. The longitudinal direction X is horizontal. The transverse direction Y of the seat thus corresponds to the transverse or lateral direction of the motor vehicle. This transverse direction corresponds to a direction perpendicular to the normal direction of travel of the vehicle. The transverse direction Y is horizontal. Finally, the vertical direction Z is a vertical direction of the seat, perpendicular to the longitudinal and transverse directions.

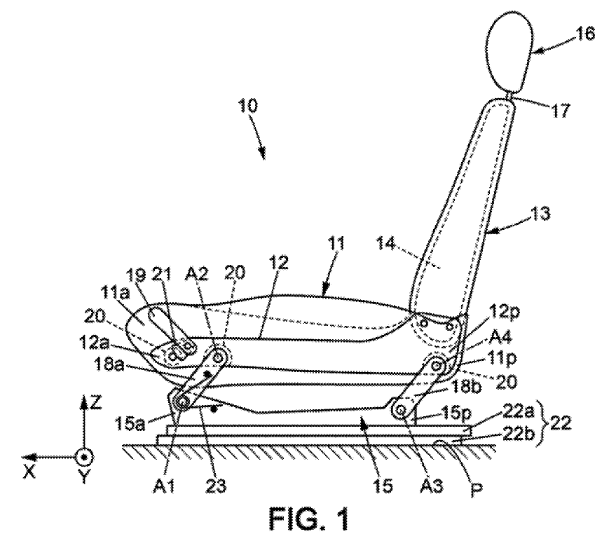

FIG. 1 schematically shows a vehicle seat 10 comprising a squab 11 with a squab frame 12, a backrest 13 with a backrest frame 14, mounted on the squab frame 12. The squab frame 12 is mounted on a base 15 via one or more hinge mechanisms. The backrest frame 13 can be secured to a headrest 16 connected to the backrest frame 13 by one or more headrest 16 attachment sockets or pins 17. In particular, the hinge mechanism(s) can be a raising mechanism and/or one or two tilting mechanisms, which can be obtained in particular but not exclusively via connecting rods 18a, 18b. For example, for each of the connecting rods 18a, 18b, the lower end is connected to the base 15 and the upper end is connected to the squab frame 12 of the vehicle seat 10. More specifically, in the example shown, a first connecting rod 18a connects the front part 15a of the base 15—mounted so as to pivot about a first transverse axis A1—to a front part 12a of the squab frame 12—mounted so as to pivot about a second transverse axis A2—and a second, rear connecting rod 18b connects the rear part 15p of the base 15—mounted so as to pivot about a third transverse axis A3—to the rear part 12p of the squab frame 12—mounted so as to pivot about a fourth transverse axis A4. In the example shown, the pivot mounts of the first and second connecting rods 18a, 18b all have axes A1-A4 parallel to the transverse direction Y.

The squab frame 12 has a right side and left side of similar architecture. In FIG. 1, only one side is shown. On the side not shown, the seat 10 has other connecting rods between the squab frame 12 and the base 15, equivalent or even identical to the connecting rods 18a, 18b shown.

If needed, the squab 11 of the seat 10 can also be fitted with a squab front edge that can be moved in height and/or longitudinal extension. In the case of the tilting movement of the squab front edge, an auxiliary connecting rod 19 connects the squab frame 12 to the squab front edge, the auxiliary connecting rod 19 being movable by an actuator 20 via a toothed sector 21. In addition, the base 15 can be slidably mounted with respect to the vehicle floor P by means of longitudinal runners 22 comprising a fixed rail 22b attached to the vehicle floor P and a movable rail 22a secured to the aforementioned base 15. The backrest 13 can be pivoted with respect to the squab 11, and in particular the backrest frame 14 with respect to the squab frame 12. The connecting rods 18a, 18b can be moved independently by respective control means or can be controlled simultaneously by synchronized control means or through a mechanical link—not shown—which can connect them. When the first connecting rod 18a is rotated trigonometrically by an actuator 20, then the front part of the squab 11a connected to the squab rises upwards, while conversely when the first connecting rod 20a is rotated clockwise then the front part 11a of the squab 11 lowers toward the floor. Similarly, when the second connecting rod 18b is rotated trigonometrically—by another actuator 20—then the rear part 11p of the squab 11 rises upwards, while when the second connecting rod 18b is rotated clockwise the rear part 11p of the squab 11 lowers toward the floor P. When both connecting rods 18a, 18b are operated simultaneously, the squab 11 moves substantially parallel to the floor P, a movement referred to as "raising". When the first connecting rod 18a is operated without the second connecting rod 18b moving, or vice versa, a tilting movement of the squab 11 is obtained. According to an arrangement shown schematically in FIG. 1, the front hinge mechanism comprising the connecting rod 18a can be equipped with a return member 23 tending to pivot the connecting rod 18a in the trigonometric direction and exerting an upward torque on the front part 11a of the squab 11, so that the effects of gravity generated by the weight of the seat 10 and/or of the occupant installed on the seat 10 can be at least partly compensated by the effect of this return member 23. A similar return member can be provided on the second connecting rod 18b. This return member can take any other form, such as a torsion bar, which can advantageously be one of the crossbars installed at axes A1-A4.

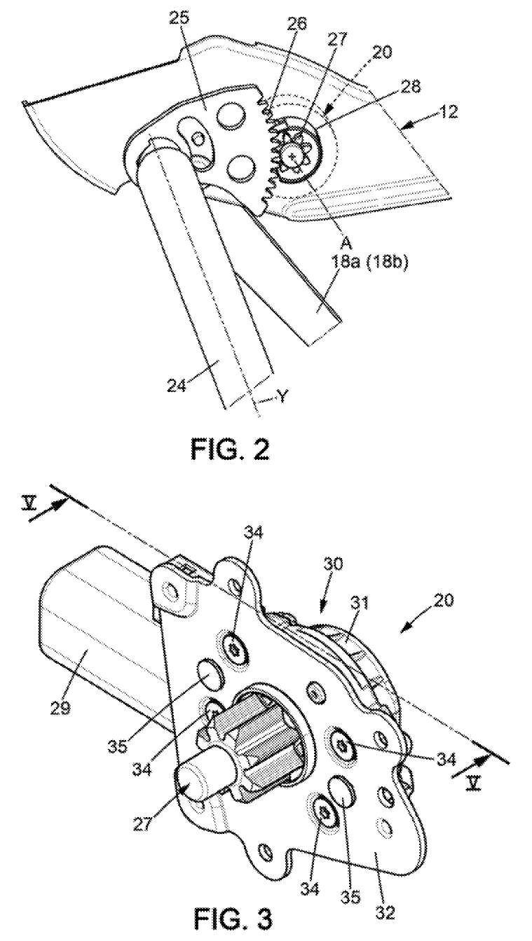

As shown in FIG. 2, the front connecting rod 18a—respectively the rear connecting rod 18b—is firmly connected to a crossbar extending along the transverse axis Y and connecting the connecting rod 18a, 18b shown to an equivalent connecting rod arranged on the other side of the squab 11, not shown. In addition, the connecting rod 18a is firmly connected to a control flange 25, which is in the form of a metal plate extending along a plane X, Z. This control flange 25 is connected directly to the crossbar 24 and/or connecting rod 18a and has, on one end of substantially circular shape, a toothed sector 26 arranged to cooperate with the actuator 20, which comprises an output pinion 27 engaging directly with the toothed sector 26. Preferentially, such an actuator 20 is arranged on only one side of the squab frame 12 of the seat 10. The other side may be without actuator 20. The output pinion 27 is arranged to rotate about an axis A substantially parallel to the transverse axis Y. A second actuator, similar to the first actuator 20, can be provided to drive the rear connecting rod 18b in a similar way.

Hereinafter, a first example actuator 20 is described in more detail, in view of FIGS. 3 to 7.

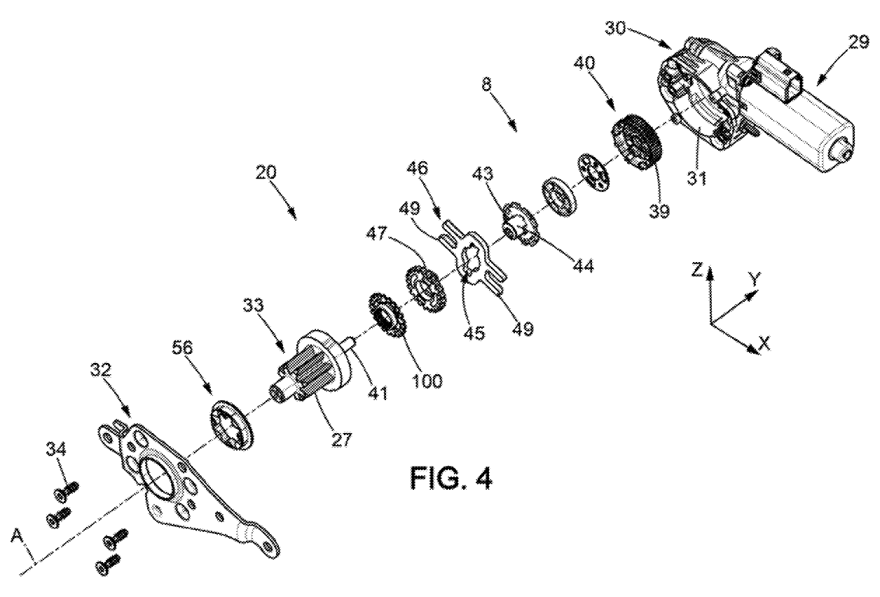

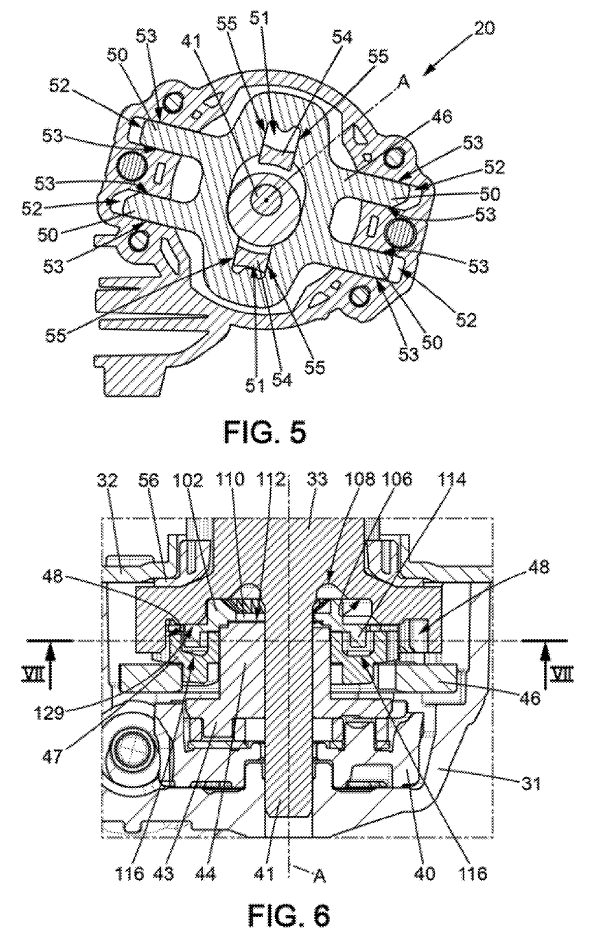

The actuator 20 comprises, as shown in FIG. 3, a motor 29, a housing 30 forming a fixed support with respect to the squab 11 of the vehicle seat 10, with a casing 31 and a flange or cover 32, and an output member 33 forming the output pinion 27. The casing 31 and cover 32 are attached together, for example by means of screws 34. Reinforcing elements 35 may also be provided between the casing 31 and the cover 32. The actuator 20 also includes a reduction gear 36, not visible in FIG. 3, which will be described below in relation to FIGS. 4 and 5, in particular.

The casing 31 is shaped like a bell or bowl. In the example shown, the casing 31 is formed from plastic material. Such plastic material may be ABS, polypropylene, polyethylene, polyamide, etc. However, the casing 31 could also be formed from an aluminum alloy, magnesium alloy or any lightweight metal alloy.

The motor 29 extends along an axis perpendicular to the axis A of rotation of the output member 33 and comprises a rotor which carries, at its end, a helical gear screw 38 centered on the axis of motor 29. The helical gear screw 38 extends inside the casing 31. The helical gear screw 38 is engaged on a first outer ring gear 39 of an input member 40 of the reduction gear 36. The input member 40 is freely rotatable about the axis A by means of a shaft 41 attached to the casing 31, preferably freely rotatable about the axis of rotation A. The shaft 41 may be integral with the output member 33, or the output member 33 may be attached to the shaft 41.

The input member 40 comprises a second, inner ring gear 42, adapted to drive an eccentric cam wheel 43 in rotation about the axis of rotation A, which eccentric cam wheel features a cam 44 that is eccentric with respect to the axis of rotation A. The cam 44 is generally cylindrical in shape, with its axis parallel to the axis of rotation A. The cam 44 thus takes the form of a substantially cylindrical pin whose axis is parallel to the axis of rotation A of the eccentric cam wheel 43, offset with respect to the axis of rotation A of the eccentric cam wheel 43.

The cam 44 extends through a first opening 45 of a slide 46 guiding an orbital gear wheel 47 driven by the cam 44 of the eccentric cam wheel 43. The gear wheel 47 is received in an inner ring gear 48 of the output member 33. The orbital gear wheel 47 has a smaller diameter and number of teeth to the inner ring gear 48 of the output member 33, in order to engage with the latter and create a reduction ratio in the manner described below.

The orbital gear wheel 47 is locked in rotation on itself, about an axis parallel to the axis of rotation A of the output member 33, by means of the slide 46.

To this end, as shown in FIG. 5, the slide 46 comprises at least one first longitudinal guide element 50, as well as at least one second longitudinal guide element 51, along two perpendicular longitudinal directions in a plane perpendicular to the axis of rotation A of the output member 33.

The first longitudinal guide element 50 is adapted to cooperate with a first counter-element 52 of the casing 31 of the housing 30. The first longitudinal guide element 50 has first guide surfaces 53 adapted to slide in or against the first counter-element 52.

The first guide surfaces 53 are adapted to guide the slide 46 so that it can only move along a line with respect to the casing 31 of the housing 30.

For example, the first guide surfaces 53 can lock the slide 46 in translation with respect to the housing 30 in a vertical direction Z, perpendicular to the longitudinal X and transverse Y directions.

The slide 46 can also be locked against rotation about the axis of rotation A relative to the housing 30. Conversely, the slide 46 may be free to slide with respect to the housing 31 along the longitudinal direction X.

The cooperation of the first longitudinal guide element 50 with the first counter-element 52 therefore locks the slide 46 in translation in the vertical direction Z and in rotation about the axis of rotation A with respect to the housing 31, while leaving it free to slide in the longitudinal direction X.

The second longitudinal guide element 51 is adapted to cooperate with a second counter-element 54 of the gear wheel 47. To this end, the second longitudinal guide element 51 has second guide surfaces 55 adapted to slide against the second counter-element 54. In this way, the orbital gear wheel 47 can only move along a line with respect to the slide 46.

The second guide surfaces 55 can, for example, lock the orbital gear wheel 47 in translation with respect to the slide 46 in the longitudinal direction X. The orbital gear wheel 47 can also be locked against rotation about the axis of rotation A with respect to the slide 46 in the vertical direction Z.

The cooperation of the second longitudinal guide element 51 with the second counter-element 54 thus locks the orbital gear wheel 47 in translation in the longitudinal direction X and in rotation about the axis of rotation A with respect to the slide 46, while leaving it free to slide in the vertical direction Z.

In this way, the gear wheel 47 can only move in circular translation with respect to the housing 30 in a plane normal to the axis of rotation A, and in particular is locked against rotation about the axis of rotation A with respect to the housing 30 due to the cooperation of the first and second longitudinal guide elements 50, 51 of the slide 46 with the first and second counter-elements 52, 54 of the casing 31 of the housing 30 and the orbital gear wheel 47.

A full circle of the orbital gear wheel 47 in the inner ring gear 48 of the output member 33 angularly shifts the output member 33 with respect to the housing 31 by the difference in the number of teeth between the orbital gear wheel 47 and the inner ring gear 48, thus generating the reduction ratio of the reduction gearbox 36.

In one embodiment, the first longitudinal guide element 50 can be formed by several extensions of rectangular cross-section, for example two or four extensions, protruding along the longitudinal direction X from a body of the slide 46. The extensions can extend two by two on either side of the body of the slide 46. In this way, the extensions can form a "U" shape with the body, on either side of the body. The two extensions can be symmetrical with respect to a longitudinal mid-plane. The flanks of the extensions can then form the first guide surfaces 53. The first counter-element 52 may then comprise longitudinal grooves in the housing 30, for example in the casing 31, to accommodate the extensions. The second longitudinal guide element 51 can be constituted by a straight opening in the slide 46, the flanks of which form the second guide surfaces 55. The second counter-element 54 may then comprise axially protruding, square-section fingers of the orbital gear wheel 47 adapted to fit into the straight opening. Alternatively, other shapes can be envisaged for the first and second longitudinal guide elements 50, 51 and the first and second counter-elements 52, 54.

As shown in FIG. 4, a bearing 56 can be arranged between the output member 33 and the cover 32 to guide the rotation of the output member 33.

In addition, the actuator 20 comprises a backlash compensation washer 100, according to a first example, functionally arranged between the orbital gear wheel 47 and the inner ring gear 48 inside the output member 33.

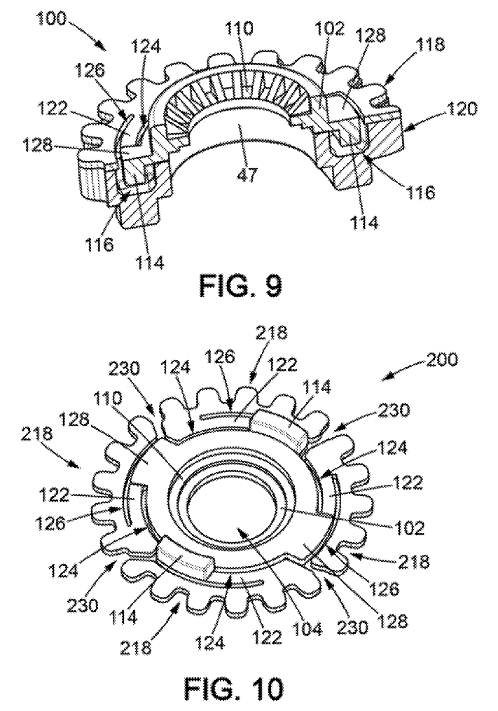

As shown in FIGS. 8 or 9 in particular, the backlash adjustment washer 100 firstly comprises a ring gear 102 defining an opening 104 adapted to be traversed by the shaft 41. Here, moreover, the ring gear 102 is substantially thicker in the direction of the axis A of rotation of the output member 33 than the rest of the backlash compensation washer 100. As shown in FIG. 6, this enables the backlash compensation washer 100 to be wedged in the direction of the axis A of rotation of the output member 33, between the output member 33 and the orbital gear wheel 47, with the crown 102 coming into contact with a front surface 106 of a housing 108 of the output member 33, which receives the backlash compensation washer 100. The front surface 106 extends in a plane perpendicular to the axis of rotation A of the output member 33.

A circular flange 110 extends inside the crown 102, in a plane normal to the direction of the axis A of rotation of the output member 33. This circular flange 110 may come into contact with a front surface 112 of the cam 44 of the eccentric cam wheel 43.

The backlash compensation washer 100 also forms studs 114, for example two or four studs 114, preferably angularly equidistant each received in a respective complementary housing 116 formed in the orbital gear wheel 47. When the studs 114 are received in the housings 116, the orbital gear wheel 47 and the backlash compensation washer 100 are rotationally connected.

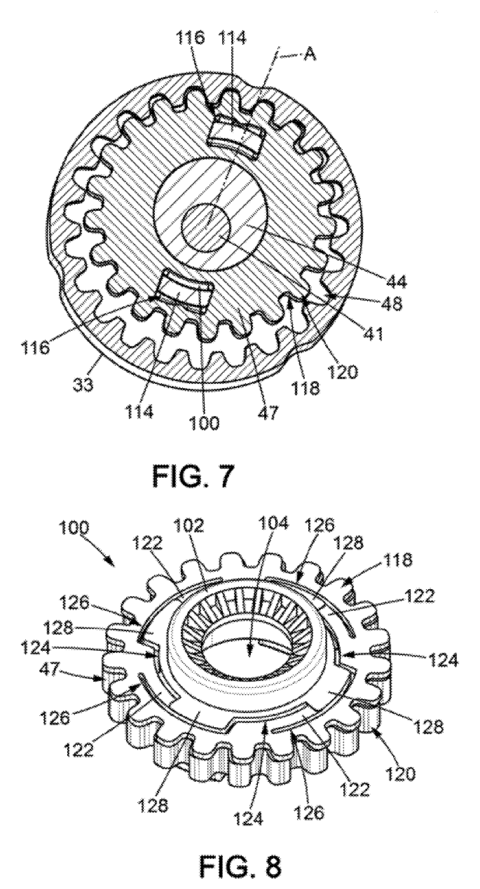

Furthermore, as can be seen in FIG. 8, the backlash compensation washer 100 has a single toothed sector 118 extending around the entire circumference of the backlash compensation washer 100. As can be seen in FIG. 7, the toothed sector 120 of the backlash compensation washer 100 is angularly offset around the common axis of the orbital gear 47 and the backlash compensation washer 100, relative to the toothed sector 120 of the orbital gear wheel 47. The toothed sector 118 of the backlash adjustment washer 100 is adapted to cooperate with the teeth of the inner ring 48 of the output member 33.

Finally, the backlash compensation washer 100 has arms 122 extending between the ring gear 102 and the toothed sector 118. Here, the compensation washer 100 has four such arms 122, identical and angularly equidistant. Each arm 122 extends substantially in an arc of a circle. Each arm 122 is separated from the ring gear 102 by a first slot 124 shaped like the arc of a circle. Each arm 122 is also separated from the toothed sector 118 by a second slot 126 shaped like the arc of a circle. The arms 122 can thus be resiliently deformable, allowing slight movement of the toothed sector 118 around the axis of the backlash compensation washer 100, relative to the ring gear 102 and, consequently, the orbital gear wheel 47. In this way, the deformation of the arms 122 keeps the teeth 118 of the backlash compensation washer 100 in contact with the teeth 120 of the inner ring gear 48 of the output member 33. In this way, a high degree of backlash is avoided, which can lead to noise during use and synchronization losses in the reduction gear 36.

Furthermore, as can be seen in FIG. 8, the base 128 of each arm 122, by which the arm 122 is connected to the ring gear 102, can be thicker, so as to protrude in the direction of the axis A of rotation of the output member 33, relative to the rest of the arm 122. This base 128 can then be in contact with a front surface 129 of the output member 33, to help hold the backlash adjustment washer 100 in place in the actuator 20.

The backlash adjustment washer 100 is made, for example, of metal or, preferably, plastic, to allow for the arms 122 to be resiliently deformed.

FIG. 10 shows a second example of a backlash compensation washer 200, in particular the side of the backlash compensation washer 200 intended to face the orbital gear wheel 47. The backlash washer 200 differs from the first example described above, in that it comprises four distinct toothed sectors 218, separated in pairs by an orthoradial gap 230. As a result of the orthoradial gaps 230, the arms 122 of the backlash compensation 200 can be significantly softer.

Thus, the backlash adjustment washer 200 is more particularly configured to be made of metal, although it can also be made of plastic.

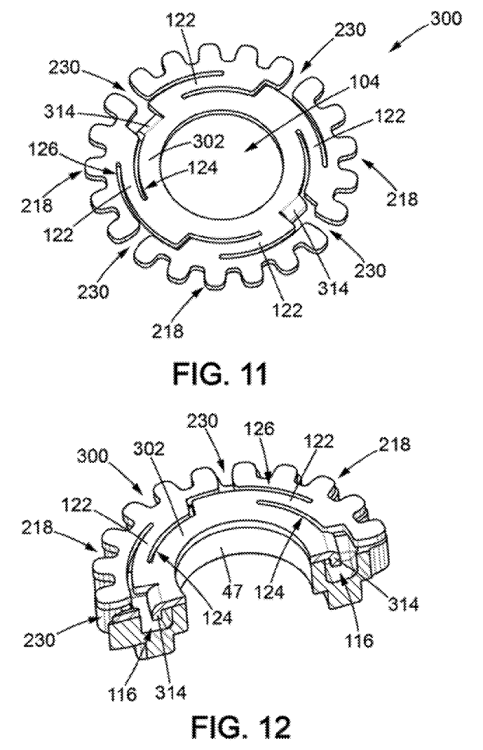

Finally, FIGS. 11 and 12 show a third example of a backlash compensation washer 300 without studs 114, but with lugs 314 instead, obtained for example by bending radial tongues. The backlash compensation washer 300 can thus be produced by stamping, for example, and then bending the lugs 314. The backlash compensation washer 300 is therefore particularly suited to being made of metal, although it can also be made of plastic.

In addition, the central ring gear 302 is substantially flat. Also, to enable the arms 122 to deform resiliently, they can extend along a substantially helical path.

This disclosure is not limited to the examples described above solely for non-limiting illustrative purposes; rather, it encompasses all the variants that the person skilled in the art may consider in the context of the protection sought.

In the automotive field, in particular, a vehicle seat may have a squab frame arranged on a base, the squab being equipped with a squab-raising movement.

In this type of comparative configuration, a comparative actuator is provided with an output member driven selectively in rotation to make the squab frame rise and/or fall. The output member comprises a toothing engaged with a toothed sector facing one another. The toothed sector is connected to the kinematics of raising and lowering the squab.

The comparative actuator comprises a reduction gear with a high reduction ratio in order to change from a rapid rotation of an electric motor to a slow or very slow rotation of the output member. The reduction gear in question has a functional clearance necessary for its operation in all circumstances. This clearance is present in particular when the electric motor is not controlled and the output pinion is not supposed to move.

Furthermore, the squab raising movement may be provided with an upward resilient return system in order to compensate for all or some of the weight of the occupant seated on the seat, and secondarily to a part of the weight of the seat itself.

The clearance of the reduction gear can be perceptible in particular in the situations when the load polarity changes, for example when an occupant sits down on the squab or when an occupant leaves the squab.

To conceal the clearance of the reduction gear, a comparative actuator comprising a friction ring mounted around the output member and secured in rotation to the output member. The friction ring comprising a skirt and the actuator housing comprises an inner bearing to receive the skirt. The skirt is in contact with at least the inner bearing in order to form a friction brake between the output member and the inner bearing.

By virtue of these arrangements, the contact between the skirt and the inner bearing generates a friction which is exerted as a brake when a rotation torque is applied to the output pinion.

However, this friction ring tends to reduce actuator efficiency when the actuator is motorized.

The present disclosure improves the situation.

To this end, a vehicle seat actuator is proposed comprising:

a motor with an output shaft,

a reduction gear driven by the output shaft of the motor, the reduction gear comprising an eccentric cam wheel driving an orbital gear wheel,

an output member, the output member forming a pinion and an inner ring gear adapted to receive the orbital gear wheel, the pinion and the inner ring gear being aligned along an axis of rotation of the output member,

a backlash compensation washer comprising at least one member for rotational coupling to the orbital gear wheel and at least one toothed sector adapted to cooperate with the inner ring gear of the output member, the backlash compensation washer comprising, between the rotational coupling member and the at least one toothed sector, at least one resiliently deformable arm.

According to preferred embodiments, the vehicle seat actuator comprises one or more of the following features, taken alone or in combination:

the orbital gear wheel is adapted to be moved in circular translation in the inner ring gear of the output member, the actuator preferably comprising a guide slide for the orbital gear wheel;

the at least one coupling member comprises at least one of a stud and a lug, secured to a central ring gear, the stud or lug being adapted to be received in a complementary housing of the orbital gear wheel in order to rotationally connect the backlash adjustment washer and the orbital toothed wheel;

the at least one arm extends in the shape of an arc of a circle between a first end, integral with the central ring gear if applicable, and a second end, integral with the at least one toothed sector;

the vehicle seat actuator comprises a plurality of distinct toothed sectors, separated from one another by an orthoradial gap;

each arm is attached to a single toothed sector;

the vehicle seat actuator comprises a single toothed sector extending over substantially the entire circumference of the backlash compensation washer;

the backlash compensation washer is substantially flat, with the exception of the at least one coupling member, in particular the at least one lug if applicable;

the backlash compensation washer comprises at least one relief projecting in the direction of the axis of rotation of the output member, adapted to come into contact with a front surface of the output member, normal to the axis of rotation of the output member; and

the at least one relief comprises at least one of:

the central ring gear; and

an arm base connecting the arm to the central ring gear.

According to another aspect, a vehicle seat is described, comprising an actuator as described above, in all combinations thereof.

The vehicle seat may in particular comprise:

a base;

a squab frame;

at least one hinge mechanism connecting the squab frame to the base, each hinge mechanism comprising at least one connecting rod mounted to rotate freely with respect to the squab frame at a first end and to the base at a second end;

at least one actuator as described above, in any combination thereof, to control the rotation of the at least one connecting rod with respect to the base or to the squab frame.

According to another aspect, a vehicle seat is proposed comprising:

a squab frame;

a device for raising the seat front edge;

at least one connecting rod connecting the squab frame to the seat front edge raising device;

at least one actuator as described above, in any combination thereof, to control rotation of the at least one connecting rod with respect to the squab frame or seat front edge raising device.

1. An actuator for a vehicle seat, comprising:
a motor with an output shaft,
a reduction gear driven by the output shaft of the motor, the reduction gear comprising an eccentric cam wheel driving an orbital gear wheel,
an output member, the output member forming a pinion and an inner ring gear adapted to receive the orbital gear wheel, the pinion and the inner ring gear being aligned along an axis of rotation of the output member,
a backlash compensation washer, comprising at least one member for rotational coupling to the orbital gear wheel, and at least one toothed sector adapted to cooperate with the inner ring gear of the output member, the backlash compensation washer comprising, between the rotational coupling member and the at least one toothed sector, at least one resiliently deformable arm.

2. The actuator for a vehicle seat according to claim 1, wherein the orbital gear wheel is adapted to be moved in circular translation in the inner ring gear of the output member.

3. The actuator for a vehicle according to claim 2, wherein the actuator comprises a slide guiding the orbital gear wheel.

4. The actuator for a vehicle seat according to claim 1, wherein the at least one coupling member comprises at least one of a stud and a lug, integral with a central ring gear, the stud or the lug being adapted to be received in a complementary housing of the orbital gear wheel to rotationally connect the backlash compensation washer and the orbital gear wheel.

5. The actuator for a vehicle seat according to claim 1, wherein the at least one arm extends in the shape of an arc of a circle between a first end and a second end, integral with the at least one toothed sector.

6. The actuator for a vehicle seat according to claim 4, wherein the at least one arm extends in the shape of an arc of a circle between a first end, integral with the central ring gear, and a second end, integral with the at least one toothed sector.

7. The actuator for a vehicle seat according to claim 1, comprising a plurality of distinct toothed sectors, separated from one another by an orthoradial gap.

8. The actuator for a vehicle seat according to claims claim 5, comprising a plurality of distinct toothed sectors, separated from one another by an orthoradial gap, wherein each arm is integral with a single respective toothed sector.

9. The actuator for a vehicle seat according to claim 1, comprising a single toothed sector extending around substantially the entire circumference of the backlash compensation washer.

10. The actuator for a vehicle seat according to claim 1, wherein the backlash adjustment washer is substantially flat, with the exception of the at least one connecting member).

11. The actuator for a vehicle seat according to claim 4, wherein the backlash adjustment washer is substantially flat, with the exception of the at least one lug.

12. The actuator for a vehicle seat according to claim 1, wherein the backlash adjustment washer comprises at least one relief projecting in the direction of the axis of rotation of the output member, adapted to come into contact with a front surface of the output member, normal to the axis of rotation of the output member.

13. The actuator for a vehicle seat according to claim 4, wherein the backlash adjustment washer comprises at least one relief projecting in the direction of the axis of rotation of the output member, adapted to come into contact with a front surface of the output member, normal to the axis of rotation of the output member and wherein the at least one relief comprises at least one of:
the central ring gear; and
a base of an arm connecting the arm to the central ring gear.

14. A vehicle seat, comprising the actuator according to claim 1.
